(19) United States
(12) Patent Application Publication
(10) Pub. No.: US 2020/0255028 A1
(43) Pub. Date: Aug. 13, 2020

(54) AUTONOMOUS DRIVING USING AN ADJUSTABLE AUTONOMOUS DRIVING PATTERN

(71) Applicant: CARTICA AI LTD, Tel Aviv (IL)

(72) Inventor: Igal Raichelgauz, Tel Aviv (IL)

(73) Assignee: CARTICA AI LTD, TEL AVIV (IL)

(21) Appl. No.: 16/780,930

(22) Filed: Feb. 4, 2020

Related U.S. Application Data
(60) Provisional application No. 62/802,716, filed on Feb. 8, 2019.

(51) Int. Cl. B60W 60/00; G05D 1/00; G06F 16/23

(52) U.S. Cl. CPC B60W 60/0013; G05D 1/0088; G06F 16/2379; B60W 2520/10; B60W 2520/105; G06N 20/00; B60W 2554/20; B60W 2555/20; B60W 2540/215; B60W 2554/4029; B60W 2520/06

(57) ABSTRACT

A method that may include receiving driving information and environmental metadata indicative of information sensed by the vehicle; detecting multiple driving events encountered during the driving over the path; determining driving events; for each driving event, determining a comfort based autonomous driving pattern information; for each driving event, determining an driving event identifier; and storing in at least one data structure a driving event identifier for each one of the multiple types of driving events, and a comfort based autonomous driving pattern information.

### BACKGROUND

An autonomous driving system is expected to control, in the near future, an autonomous vehicle in an autonomous manner.

A driving pattern applied by the autonomous driving system may cause a certain human within the vehicle to be uncomfortable.

This may cause various users not to purchase an autonomous vehicle and/or may cause automatic driving system vendors to develop sub-optimal driving patterns.

There is a growing need to provide a method, system and non-transitory computer readable medium for providing better driving patterns.

### SUMMARY

There may be provided a method for comfort based autonomous driving, the method may include receiving, from vehicles, multiple driving event metadata or generating the multiple driving event metadata; wherein the multiple driving event metadata may be related to multiple driving events; wherein each driving event metadata may be associated to a driving event and comprises (a) environmental metadata regarding an environment of the vehicle that may be related to the driving event, and (b) physical metadata indicative of at least one physical parameter of the vehicle that may be related to the driving event; generating driving event identifiers for identifying each driving event; evaluating one or more impact parameters for each driving event, wherein the evaluating may be responsive to the physical metadata related to the driving event, wherein the one or more impact parameters may be indicative of an impact of the driving event on a person located within a vehicle; receiving or generating one or more allowable values of the one or more impact parameters, the one or more allowable values represent an allowable comfort of the person; determining, based on the one or more allowable values of the one or more impact parameters, comfort based autonomous driving pattern information, wherein the comfort based autonomous driving pattern information may be indicative of a comfort based autonomous driving pattern to be applied by the vehicle during an occurrence of the driving event; and storing in at least one data structure (a) the driving event identifiers, and (b) comfort based autonomous driving pattern information for each one of the driving events.

The one or more physical parameters may be selected out of speed, acceleration, displacement, and direction of propagation.

The generating the multiple driving event metadata may include (i) receiving, from the vehicles, environmental information and physical information acquired by the vehicles during various time windows, (ii) detecting multiple driving events that occurred during the time windows, and (iii) extracting the environmental information and physical information acquired by the vehicles during the driving events.

The method may include generating the one or more allowable values of the one or more impact parameters may be based on a statistical analysis of driving patterns applied by the multiple vehicle during the driving events.

The method may include generating the one or more allowable values of the one or more impact parameters may be based on typical driving patterns applied by the multiple vehicle during the driving events.

The method may include generating the one or more allowable values of the one or more impact parameters may be based on feedback from at least one person within at least one of the multiple vehicles.

The method may include generating the one or more allowable values of the one or more impact parameters may be based on a monitoring process that involve monitoring at least one response of at least one person within at least one of the multiple vehicles to at least one of the multiple driving events.

The multiple driving events may be related to obstacles.

The multiple driving events may be related to physical obstacles.

The multiple driving events may be related to weather conditions.

The allowable comfort of the person may be represented by one or more comfort threshold.

The determining of the comfort based autonomous driving pattern information, may be responsive to a plurality of allowable values of a plurality of impact parameters.

There may be provided a non-transitory computer readable medium that stores instructions for: receiving, from vehicles, multiple driving event metadata or generating the multiple driving event metadata; wherein the multiple driving event metadata may be related to multiple driving events; wherein each driving event metadata may be associated to a driving event and may include (a) environmental metadata regarding an environment of the vehicle that may be related to the driving event, and (b) physical metadata indicative of at least one physical parameter of the vehicle that may be related to the driving event; generating driving event identifiers for identifying each driving event; evaluating one or more impact parameters for each driving event, wherein the evaluating may be responsive to the physical metadata related to the driving event, wherein the one or more impact parameters may be indicative of an impact of the driving event on a person located within a vehicle; receiving or generating one or more allowable values of the one or more impact parameters, the one or more allowable values represent an allowable comfort of the person; determining, based on the one or more allowable values of the one or more impact parameters, comfort based autonomous driving pattern information, wherein the comfort based autonomous driving pattern information may be indicative of a comfort based autonomous driving pattern to be applied by the vehicle during an occurrence of the driving event; and storing in at least one data structure (a) the driving event identifiers, and (b) comfort based autonomous driving pattern information for each one of the driving events.

The one or more physical parameters may be selected out of speed, acceleration, displacement, and direction of propagation.

The generating of the multiple driving event metadata may include (i) receiving, from the vehicles, environmental information and physical information acquired by the vehicles during various time windows, (ii) detecting multiple driving events that occurred during the time windows, and (iii) extracting the environmental information and physical information acquired by the vehicles during the driving events.

The non-transitory computer readable medium may store instructions for generating the one or more allowable values of the one or more impact parameters may be based on a statistical analysis of driving patterns applied by the multiple vehicle during the driving events.

The non-transitory computer readable medium may store instructions for generating the one or more allowable values of the one or more impact parameters may be based on typical driving patterns applied by the multiple vehicle during the driving events.

The non-transitory computer readable medium may store instructions for generating the one or more allowable values of the one or more impact parameters may be based on feedback from at least one person within at least one of the multiple vehicles.

The non-transitory computer readable medium may include may store instructions for generating the one or more allowable values of the one or more impact parameters may be based on a monitoring process that involve monitoring at least one response of at least one person within at least one of the multiple vehicles to at least one of the multiple driving events.

The multiple driving events may be related to obstacles.

The multiple driving events may be related to physical obstacles.

The multiple driving events may be related to weather conditions.

The allowable comfort of the person may be represented by one or more comfort threshold.

The determining of the comfort based autonomous driving pattern information, may be responsive to a plurality of allowable values of a plurality of impact parameters.

There may be provided a method for driving a vehicle, the method may include receiving, by the vehicle, multiple driving event identifiers related to multiple types of driving events that occurred during a driving of the vehicle over a path, and (b) comfort based autonomous driving pattern information for each one of the multiple types of driving events; wherein a comfort based autonomous driving pattern information of an driving event may be indicative of a comfort based autonomous driving pattern associated to the driving event; sensing, by the vehicle and while driving on a current path, currently sensed information that may be indicative of a vicinity of the vehicle and may be indicative of a current path; searching, based on the currently sensed information, for a driving event identifier out of the multiple driving event identifiers; when detecting an driving event then applying an autonomous driving pattern that may be associated to the driving event.

### BRIEF DESCRIPTION OF THE DRAWINGS

The embodiments of the disclosure will be understood and appreciated more fully from the following detailed description, taken in conjunction with the drawings in which:

FIGS. 1-3 illustrate examples of methods;

FIG. 4 is a partly-pictorial, partly-block diagram illustration of an exemplary obstacle detection and mapping system, constructed and operative in accordance with embodiments described herein;

FIG. 5 is a block diagram of an exemplary autonomous driving system to be integrated in the vehicle of FIG. 4;

FIG. 6 is a block diagram of an computerized system; and

FIGS. 7-18 illustrate various examples of driving events.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

There may be provided a system, method and non-transitory computer readable medium that adjusts the autonomous driving pattern to a desired comfort level of one or more persons within a vehicle. The adjustment can be done in an automatic manner (without human intervention) and especially in an unsupervised manner—thus providing a highly efficient and accurate manner to tailor the autonomous driving patterns.

A driving event may be a passage of an obstacle, a bypassing of an obstacle, driving at certain weather condition, driving in a curved section of a road, reacting to a presence of a zebra crossing, driving towards a crossroad, driving in a roundabout, a change in any driving parameter (acceleration, direction of propagation), turning the vehicle, bypassing a vehicle, parking, entering a scene that required a driver intervention, performing complex driving maneuvers, any driving event related to the driving that may cause a person within the vehicle to feel uncomfortable, and/or any combination of any one of the above. For example—a driving event may involve passing a bumper at a certain velocity, passing a bumper under a certain amount of rain, passing a bumper and entering a hole, and the like.

Driving events may be classified or partitioned to driving event types. Driving events of the same type may share a common attribute. For example—passing different bumps of similar structure may belong to the same type of driving events, passing the same bump at different speeds may be regarded as the same type of driving events, passing bumps located at different locations may be regarded as driving events of the same type, and the like.

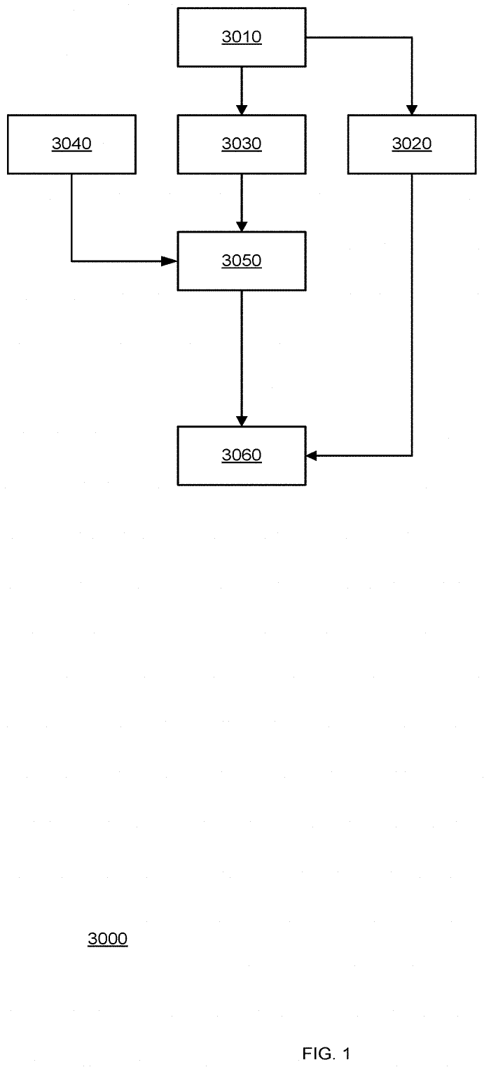

FIG. 1 illustrate method 3000 for comfort based autonomous driving.

Method 3000 may be applied by a computerized system that is a remote computerized system (not located in a vehicle) or a computerized system located in one or more vehicle. For example—multiple vehicle computers located within multiple vehicles can participate in the execution of the method.

Method 3000 may start by step 3010 of receiving, from vehicles, multiple driving event metadata or generating the multiple driving event metadata.

The multiple driving event metadata is related to multiple driving events.

Each driving event metadata is associated to a driving event and includes (a) environmental metadata regarding an environment of the vehicle that is related to the driving event, and (b) physical metadata indicative of at least one physical parameter of the vehicle that is related to the driving event.

The environments metadata may represent sensed information about the environment of the vehicle—including the road or path segments that are contacted by the vehicle, as well as the surrounding of the vehicle, any object or element that can be seen or otherwise sensed by one or more vehicle sensors.

The physical metadata may represent sensed information about forces, pressures, acceleration, displacement, direction of propagation, turns, and the like.

The driving event metadata may be sensed by one or more sensors out of visual sensors, acoustic sensor, audio sensors, infrared sensor, cameras, radars, sonars, LIDAR modules, accelerators, shock sensors, velocity sensors, telemetry sensors and any sensor that monitors the operation of one or more vehicle component (such as brakes, suspension, motor, gear, driving wheel, and the like) that may directly or indirectly indicate about the driving event.

When step 3010 includes receiving the multiple driving event metadata then a vehicle that sends a driving event metadata detects the occurrence of the driving event and transmits the metadata related to the driving event.

When step 3010 includes generating the driving event metadata then the vehicles that experiences the driving event either are unaware of the occurrence of the driving event or from any other reason do not allocate resources for generating the driving event metadata.

The generating of the multiple driving event metadata may include (i) receiving, from the vehicles, environmental information and physical information acquired by the vehicles during various time windows, (ii) detecting multiple driving events that occurred during the time windows, and (iii) extracting the environmental information and physical information acquired by the vehicles during the driving events.

Step 3010 may be followed by steps 3020 and 3030.

Step 3030 may include generating driving event identifiers for identifying each driving event. A driving event identifier will enable a vehicle to identity a driving event—preferably before the driving event occurs—in order to allow the vehicle to respond to future occurrence of the driving event in a manner that complies with a desired comfort level.

Step 3030 may include evaluating one or more impact parameters for each driving event. The valuating is responsive to the physical metadata related to the driving event. The one or more impact parameters are indicative of an impact of the driving event on a person located within a vehicle.

The one or more impact parameters may be directly measured by one or more sensors that sense the impact on a person within a vehicle (for example—one or more sensors located within a seat of the vehicle, attached to a seat of the vehicle, attached to a safety belt, and the like), and/or may be indirectly measured by sensors located elsewhere in the vehicle.

The indirect measurement may involve converting a measurement related to a vehicle component that does not contact a person of a vehicle (for example—a shock measured by a shock absorber sensor) to an impact parameter. This can be done using a model of the vehicle, or a mapping between the indirect measurement and the impact parameter. The mapping may learnt during a testing period, by comparing readings of indirect sensors and direct sensors (that directly measure the impact), by receiving feedback from persons, and the like.

Method 3000 may also include step 3040 of receiving or generating one or more allowable values of the one or more impact parameters, the one or more allowable values represent an allowable comfort of the person.

The one or more allowable values of the one or more impact parameters may be generated based on a statistical analysis of driving patterns applied by the multiple vehicle during the driving events.

For example—it may be assumed that most drivers (or at least a certain amount of drivers—for example 30%, 40%, 50%) will drive in a manner corresponds to an allowable comfort of the driver. Thus—typical values (or patterns) of the one or more impact parameters (or more moderate values) may represent one or more impact parameters of one or more allowable values.

Yet for another example—the generating of the one or more allowable values of the impact parameter may include calculating the distribution of values of one or more impact parameters and selecting a range of impact parameter values that represent calmer driving patterns.

For example—the driving event may be passing a bumper and the impact parameter may be an acceleration felt by a person within the vehicle when passing the bumper. The distribution of acceleration values (felt by a person when passing a bumper). The generating of the one or more allowable values may include selecting one or more allowable values acceleration values that are either (a) typical, (b) lower by a certain amount (or certain degree) than typical, (c) located within a predefined percentile of the distribution, (b) about an average of the acceleration values, (d) below the average acceleration value, and the like.

Yet for another example—the driving event may be passing a bumper and the impact parameter may be an displacement (for example vertical displacement) felt by a person within the vehicle when passing the bumper. The distribution of displacement values (felt by a person when passing a bumper). The generating of the one or more allowable values may include selecting one or more allowable values displacement values that are either (a) typical, (b) lower by a certain amount (or certain degree) than typical, (c) located within a predefined percentile of the distribution, (b) about an average of the displacement values, (d) below the average displacement value, and the like.

It should be noted that step 3040 may include generating a combination of one or more allowable values of the one or more impact parameters. Thus—the person in the vehicle will feel comfortable when experiencing a combination of different impact parameter values—for example—when passing a bump the displacement should not exceed X centimeters (or be within a certain range) and the acceleration should not exceed Y m/s² (or be within a certain range).

Step 3040 may be based, at least in part, on feedback from at least one person within at least one of the multiple vehicles and/or by monitoring one or more persons in the vehicle. The feedback and/or the monitoring may include receiving and/or detecting gestures (such as grabbing the safety belt, grabbing another element of the vehicle, performing any gesture that is indicative of inconvenience), screaming, requesting the driver to slow down, providing input to a man machine interface of the vehicle, providing input after exiting the vehicle, pressing the brakes when the vehicle is driving at an autonomous mode, exhibiting one or more face expressions, and the like.

The monitoring may include monitoring after one or more physiological parameters of one or more persons such as heart rate, respiration, blood pressure, and the like. These parameters may be be indicative of the comfort level of the person.

Steps 3030 and 3040 may be followed by step 3050 of determining, based on the one or more allowable values of the one or more impact parameters, comfort based autonomous driving pattern information, the comfort based autonomous driving pattern information is indicative of a comfort based autonomous driving pattern to be applied by the vehicle during an occurrence of the driving event and even before the occurrence of the driving event.

The comfort based autonomous driving pattern should guarantee that during the driving event a person within the vehicle is comfortable—that the one or more one or more impact parameters are of an allowable value.

The comfort based autonomous driving pattern related to a driving event may involve adjusting the driving of the vehicle before the occurrence of the driving event so that during the driving event the one or more impact parameters have one or more allowable values.

When the future occurrence of the driving event is detected the vehicle is driven in a certain manner—and has a current driving parameters—for example has a certain acceleration, speed and/or direction of driving. The current driving parameters may be changed before the occurrence of the driving event so that during the driving event the one or more impact parameters have one or more allowable values.

For example—the speed and/or acceleration and/or the direction of driving should be sent (or determined) before the occurrence of the driving event. The comfort based autonomous driving pattern is set to perform these changes (if required).

For example—if a certain bumper may be passed at a certain speed (for example—20 km/h) and at certain acceleration (for example—0 m/s²), and if the vehicle detects the obstacle at a certain distance (for example 100 meters) in advance which driving at another speed (for example 40 km/h) and at another acceleration (for example 1 m/s²)—then the comfort based autonomous driving pattern should change the velocity of the vehicle (for example slow from 40 km/h to 20 km/h) and change the acceleration (when reaching the bumper) before reaching the bumper. Step 3050 may determine the required change and the manner in which the change is implemented.

Step 3050 may be responsive to at least one other autonomous driving rule related to a driving of the vehicle during an autonomous driving mode.

The at least one other autonomous driving rule may be a safety rule. For example—the safety rule may limit a speed of the vehicle, may limit an acceleration of the vehicle, may increase a required distance between vehicles, and the like.

The at least one other autonomous driving rule may be a power consumption rule. The power consumption rule may limit some maneuvers that may involve a higher than desired power consumption of the vehicle.

The at least one other autonomous driving rule may be a default driving pattern that should have been applied by the autonomous driving system at the absence of method 3000.

The at least one other autonomous driving rule may be a human intervention policy of a vehicle that may define certain criteria human intervention such as the danger level of a situation, the complexity of the situation (especially complexity of maneuvers required to overcome the situation), the potential damage that may result to the vehicle, driver or surroundings due to the situation. A human intervention policy of a vehicle may also define certain situations that require human intervention—such as specific locations (for example near a cross road of a school), or specific content (near a school bus), and the like.

Step 3050 may be followed by step 3060 of responding to the determining.

Step 3060 may include at least one out of:
storing in at least one data structure (a) the driving event identifiers, and (b) comfort based autonomous driving pattern information for each one of the driving events.
Transmitting to one or more vehicles (a) the driving event identifiers, and (b) comfort based autonomous driving pattern information for each one of the driving events.
Requesting a vehicle to apply the comfort based autonomous driving pattern.
Instructing a vehicle to apply the comfort based autonomous driving pattern.

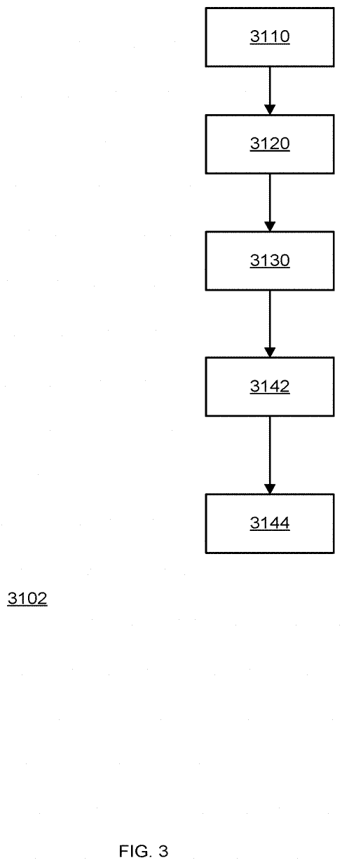

FIG. 3 illustrates method 3100 for driving a vehicle.

Method 3100 may start by step 3110 of receiving, by the vehicle, driving event identifiers, and comfort based autonomous driving pattern information for each one of the driving events.

Step 3110 may be followed by step 3120 of sensing, by the vehicle and while driving on a current path, currently sensed information that is indicative of an environment of the vehicle.

Step 3120 may be followed by step 3130 of searching, based on the currently sensed information, for a driving event identifier.

When detecting a future occurrence of a driving event then step 3130 is followed by step 3140 of applying the comfort based autonomous driving pattern related to the driving event.

Once the driving event ends (this should be detected by the vehicle) the autonomous driving system may apply another autonomous driving pattern.

FIG. 3 illustrates method 3102 for driving a vehicle.

Method 3102 may start by step 3110 of receiving, driving event identifiers, and comfort based autonomous driving pattern information for each one of the driving events.

Step 3110 may be followed by step 3120 of sensing, by the vehicle and while driving on a current path, currently sensed information that is indicative of an environment of the vehicle.

Step 3120 may be followed by step 3130 of searching, based on the currently sensed information, for a driving event identifier.

When detecting a future occurrence of a driving event then step 3130 is followed by step 3142 of determining whether to apply a comfort based autonomous driving pattern related to the driving event.

Step 3142 may be followed by step 3144 of selectively applying, based on the determining, the comfort based autonomous driving pattern related to the driving event.

Step 3144 may include:
If determining not to apply the comfort based autonomous driving pattern related to the driving event than another autonomous driving pattern (for example a default one) may be applied.
If determining to apply the comfort based autonomous driving pattern related to the driving event then applying the comfort based autonomous driving pattern related to the driving event.

Step 3142 may be responsive to at least one other autonomous driving rule related to a driving of the vehicle during an autonomous driving mode.

The at least one other autonomous driving rule may be a safety rule. For example—the safety rule may limit a speed of the vehicle, may limit an acceleration of the vehicle, may increase a required distance between vehicles, and the like.

The at least one other autonomous driving rule may be a power consumption rule. The power consumption rule may limit some maneuvers that may involve a higher than desired power consumption of the vehicle.

The at least one other autonomous driving rule may be a default driving pattern that should have been applied by the autonomous driving system at the absence of method 3102.

Step 3142 may also be responsive to input provided by the user—for example the user may determine whether (and how) to apply the comfort based autonomous driving pattern related to the driving event.

Step 3142 may also be based on environmental conditions—for example—change in the visibility and/or humidity and/or rain or snow may affect the decision.

It should be noted that there may be more than one driver of the vehicle and that different autonomous driving pattern related to The driving event may be learnt (per driver) and applied.

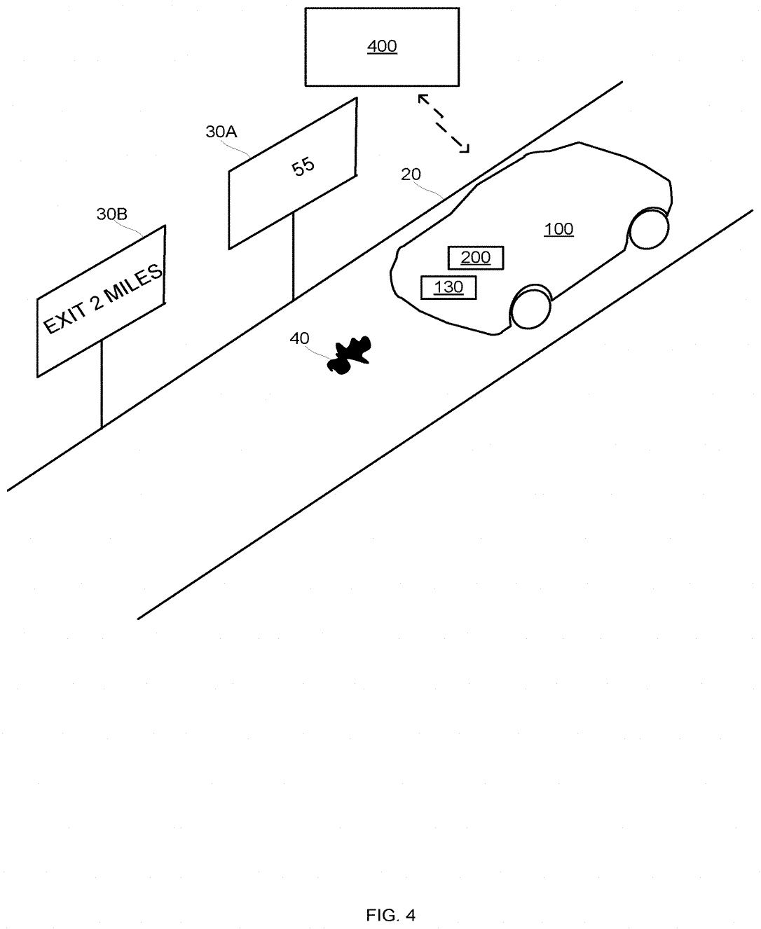

Reference is now made to FIG. 4, which is a partly-pictorial, partly-block diagram illustration of an exemplary system 10 constructed and operative in accordance with embodiments described herein.

System 10 comprises vehicle 100 and a remote computerized system such as remote computerized system 400 which may be configured to communicate with each other over a communications network such as, for example, the Internet.

In accordance with the exemplary embodiment of FIG. 4, vehicle 100 may be configured with an autonomous driving system 200 operative to autonomously provide driving instructions to vehicle 100 without the intervention of a human driver. It will be appreciated that the embodiments described herein may also support the configuration of vehicle 100 with an assisted (or “semi-autonomous”) driving system where in at least some situations a human driver may take control of vehicle 100 and/or where in at least some situations the semi-autonomous driving system provides warnings to the driver without necessarily directly controlling vehicle 100.

Remote system 400 may executed method 3000. Vehicle 10 may execute method 3100 and/or method 3102.

In accordance with the exemplary embodiment of FIG. 4, vehicle 100 may be configured with at least one sensor 130 to provide information about a current driving environment as vehicle 100 proceeds along roadway 20. It will be appreciated that while sensor 130 is depicted in FIG. 4 as a single entity, in practice, as will be described hereinbelow, there may be multiple sensors 130 arrayed on, or inside of, vehicle 130. In accordance with embodiments described herein, sensor(s) 130 may be implemented using a conventional camera operative to capture images of roadway 20 and objects in its immediate vicinity. It will be appreciated that sensor 130 may be implemented using any suitable imaging technology instead of, or in addition to, a conventional camera. For example, sensor 130 may also be operative to use infrared, radar imagery, ultrasound, electro-optics, radiography, LIDAR (light detection and ranging), etc. Furthermore, in accordance with some embodiments, one or more sensors 130 may also be installed independently along roadway 20, where information from such sensors 130 may be provided to vehicle 100 and/or computerized system 400 as a service.

In accordance with the exemplary embodiment of FIG. 4, static reference points 30A and 30B (collectively referred to hereinafter as static reference points 30) may be located along roadway 20. For example, static reference point 30A is depicted as a speed limit sign, and static reference point 30B is depicted as an exit sign. In operation, sensor 130 may capture images of static reference points 30. The images may then be processed by the autonomous driving system in vehicle 100 to provide information about the current driving environment for vehicle 100, e.g., the speed limit or the location of an upcoming exit.

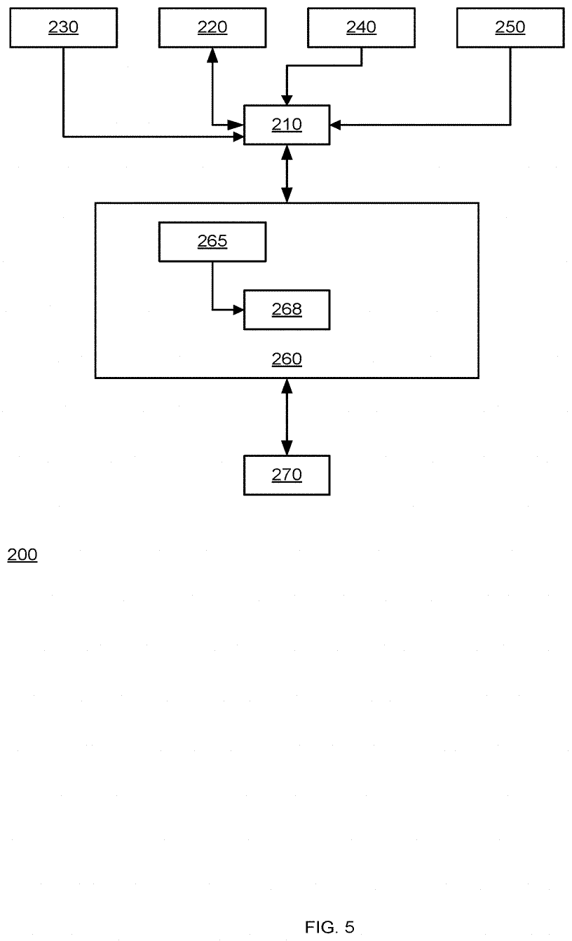

Reference is now made to FIG. 5 which is a block diagram of an exemplary autonomous driving system 200 (hereinafter also referred to as system 200), constructed and implemented in accordance with embodiments described herein.

Autonomous driving system 200 comprises processing circuitry 210, input/output (I/O) module 220, camera 230, telemetry ECU 240, shock sensor 250, autonomous driving manager 260, and database 270.

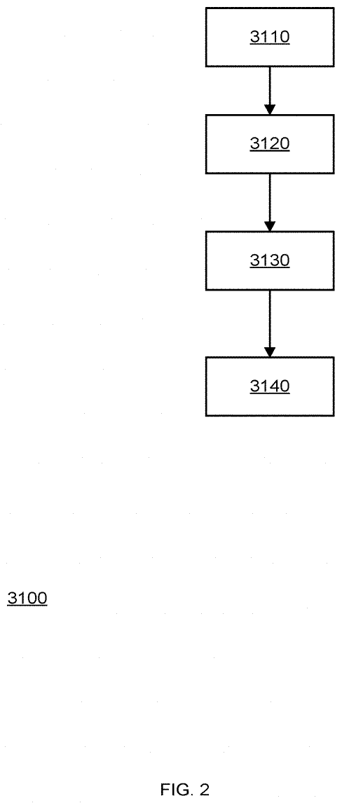

Autonomous driving manager 260 may be instantiated in a suitable memory for storing software such as, for example, an optical storage medium, a magnetic storage medium, an electronic storage medium, and/or a combination thereof. It will be appreciated that autonomous driving system 200 may be implemented as an integrated component of an onboard computer system in a vehicle, such as, for example, vehicle 100 from FIG. 4. Alternatively, system 200 may be implemented and a separate component in communication with the onboard computer system. It will also be appreciated that in the interests of clarity, while autonomous driving system 200 may comprise additional components and/or functionality e.g., for autonomous driving of vehicle 100, such additional components and/or functionality are not depicted in FIG. 2 and/or described herein.

Processing circuitry 210 may be operative to execute instructions stored in memory (not shown). For example, processing circuitry 210 may be operative to execute autonomous driving manager 260. It will be appreciated that processing circuitry 210 may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. It will similarly be appreciated that autonomous driving system 200 may comprise more than one instance of processing circuitry 210. For example, one such instance of processing circuitry 210 may be a special purpose processor operative to execute autonomous driving manager 260 to perform some, or all, of the functionality of autonomous driving system 200 as described herein.

I/O module 220 may be any suitable communications component such as a network interface card, universal serial bus (USB) port, disk reader, modem or transceiver that may be operative to use protocols such as are known in the art to communicate either directly, or indirectly, with other elements of system 10 (FIG. 1) and/or system 200, such as, for example, computerized system 400 (FIG. 4), camera 230, telemetry ECU 240, and/or shock sensor 250. As such, I/O module 220 may be operative to use a wired or wireless connection to connect to computerized system 400 via a communications network such as a local area network, a backbone network and/or the Internet, etc. I/O module 220 may also be operative to use a wired or wireless connection to connect to other components of system 200, e.g., camera 230, telemetry ECU 240, and/or shock sensor 250. It will be appreciated that in operation I/O module 220 may be implemented as a multiplicity of modules, where different modules may be operative to use different communication technologies. For example, a module providing mobile network connectivity may be used to connect to computerized system 400, whereas a local area wired connection may be used to connect to camera 230, telemetry ECU 240, and/or shock sensor 250.

In accordance with embodiments described herein, camera 230, telemetry ECU 240, and shock sensor 250 represent implementations of sensor(s) 130 from FIG. 4. It will be appreciated that camera 230, telemetry ECU 240, and/or shock sensor 250 may be implemented as integrated components of vehicle 100 (FIG. 4) and may provide other functionality that is the interests of clarity is not explicitly described herein. As described hereinbelow, system 200 may use information about a current driving environment as received from camera 230, telemetry ECU 240, and/or shock sensor 250 to determine an appropriate driving policy for vehicle 100.

Autonomous driving manager 260 may be an application implemented in hardware, firmware, or software that may be executed by processing circuitry 210 to provide driving instructions to vehicle 100. For example, autonomous driving manager 260 may use images received from camera 230 and/or telemetry data received from telemetry ECU 240 to determine an appropriate driving policy for arriving at a given destination and provide driving instructions to vehicle 100 accordingly. It will be appreciated that autonomous driving manager 260 may also be operative to use other data sources when determining a driving policy, e.g., maps of potential routes, traffic congestion reports, etc.

As depicted in FIG. 5, autonomous driving manager 260 comprises driving event detector 265 and autonomous driving pattern module 268. It will be appreciated that the depiction of driving event detector 265 and autonomous driving pattern module 268 as integrated components of autonomous driving manager 260 may be exemplary. The embodiments described herein may also support implementation of driving event detector 265 and autonomous driving pattern module 268 as independent applications in communication with autonomous driving manager 260, e.g., via I/O module 220.

Driving event detector 265 and autonomous driving pattern module 268 may be implemented in hardware, firmware, or software and may be invoked by autonomous driving manager 260 as necessary to provide input to the determination of an appropriate driving policy for vehicle 100. For example, driving event detector 265 may be operative to use information from sensor(s) 130 (FIG. 4), e.g., camera 230, telemetry ECU 240, and/or shock sensor 250 to detect or predict the future occurrence of a driving event in (or near) the driving path of vehicle 100, e.g., along (or near) roadway 20 (FIG. 4). Driving event detector may search for driving event indicators in order to the detect or predict the future occurrence of a driving event.

Autonomous driving pattern module 268 may be operative to determine an appropriate comfort based autonomous driving pattern to be applied when detecting a future occurrence of a driving event and to apply that comfort based autonomous driving pattern.

Depending on the configuration of system 100, the information from computerized system 400 may be received in a batch update process, either periodically and/or triggered by an driving event, e.g., when vehicle 100 is turned on, when vehicle 100 enters a new map area, when vehicle 100 enters an area with good wireless reception, etc.

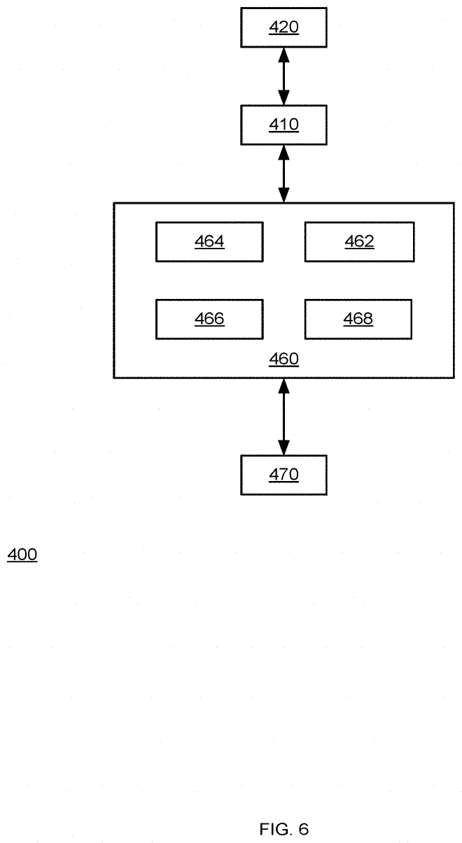

Reference is now made to FIG. 6 which is a block diagram of a computerized system 400 (hereinafter also referred to as computerized system 400), constructed and implemented in accordance with embodiments described herein.

Computerized system 400 comprises processing circuitry 410, input/output (I/O) module 420, comfort based autonomous driving pattern manager 460, and database 470. Comfort based autonomous driving pattern manager 460 may be instantiated in a suitable memory for storing software such as, for example, an optical storage medium, a magnetic storage medium, an electronic storage medium, and/or a combination thereof.

Processing circuitry 410 may be operative to execute instructions stored in memory (not shown). For example, processing circuitry 410 may be operative to execute comfort based autonomous driving pattern manager 460. It will be appreciated that processing circuitry 410 may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. It will similarly be appreciated that computerized system 400 may comprise more than one instance of processing circuitry 410. For example, one such instance of processing circuitry 410 may be a special purpose processor operative to execute the comfort based autonomous driving pattern manager 460 to perform some, or all, of the functionality of computerized system 400 as described herein.

I/O module 420 may be any suitable communications component such as a network interface card, universal serial bus (USB) port, disk reader, modem or transceiver that may be operative to use protocols such as are known in the art to communicate either directly, or indirectly, with other elements of system 10 (FIG. 4) such as, for example, system 200 (FIG. 5). As such, I/O module 420 may be operative to use a wired or wireless connection to connect to system 200 via a communications network such as a local area network, a backbone network and/or the Internet, etc. It will be appreciated that in operation I/O module 220 may be implemented as a multiplicity of modules, where different modules may be operative to use different communication technologies. For example, a module providing mobile network connectivity may be used to connect wirelessly to one instance of system 200, e.g., one vehicle 100 (FIG. 4), whereas a local area wired connection may be used to connect to a different instance of system 100, e.g., a different vehicle 100.

Comfort based autonomous driving pattern manager 460 may be an application implemented in hardware, firmware, or software that may be executed by processing circuitry 410 to provide driving event identifiers and tailored comfort based autonomous driving pattern information for each one of the multiple types of driving events.

As depicted in FIG. 4, comfort based autonomous driving pattern manager 460 may include driving event detector 462 and comfort based autonomous driving pattern generator 468.

It will be appreciated that the depiction of driving event detector 462, and comfort based autonomous driving pattern generator 468 as integrated components of autonomous driving pattern manager 460 may be exemplary. The embodiments described herein may also support implementation of driving event detector 462, and comfort based autonomous driving pattern generator 468 as independent applications in communication with autonomous driving pattern manager 460, e.g., via I/O module 420.

Driving event detector 462 and comfort based autonomous driving pattern generator 468 may be implemented in hardware, firmware, or software and may be invoked by autonomous driving pattern manager 460 as necessary to provide obstacle warnings and associated driving policies to vehicles 100. For example,

Autonomous driving pattern manager 460 may store driving event metadata received from a vehicle in database 270 for use by driving event detector 462, and comfort based autonomous driving pattern generator 468.

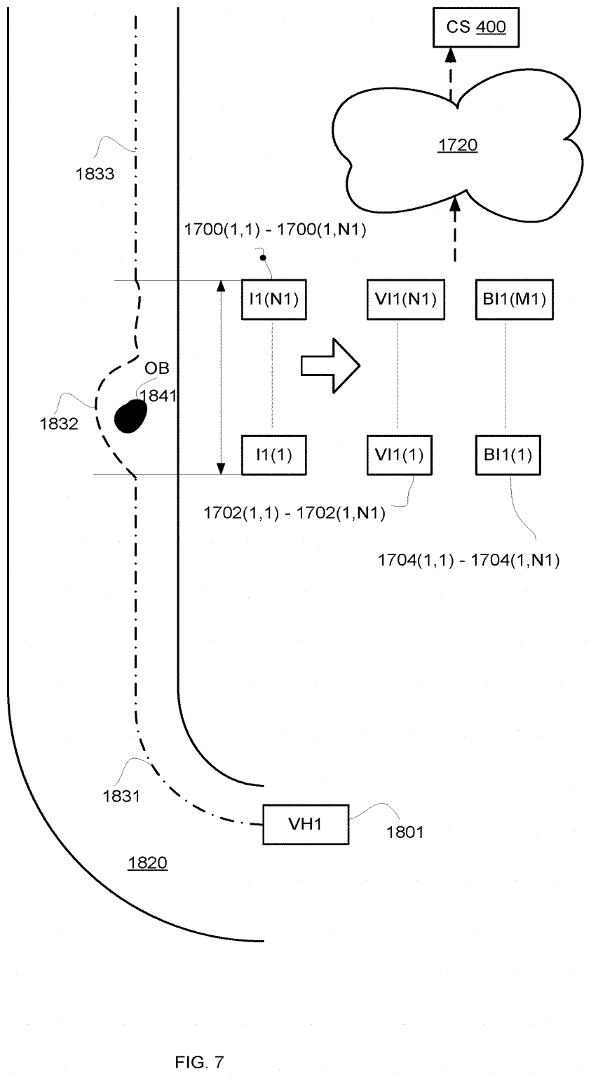

Each one of FIGS. 7-18 may illustrate a learning process and/or an applying process.

During the learning process the vehicle may encounter driving events, driving information and Environmental metadata indicative of information sensed by the vehicle generated by the vehicle and sent to the—that may apply method 2000.

During an applying process the vehicle may benefit from the products of the learning process—and may execute method 3100 and/or 3102.

Thus each one of FIGS. 7-18 may illustrate different driving events of different driving events that once detected by the vehicle—the vehicle may apply comfort based autonomous driving patterns.

For simplicity of explanation the following text may refer to one of these processes.

FIG. 7 illustrates a first vehicle (VH1) 1801 that propagates along a road 1820. First vehicle 1801 performs a maneuver 1832 that is suspected as being an obstacle avoidance maneuver when encountered with obstacle 1841. Maneuver 1832 is preceded by a non-suspected maneuver 1831 and is followed by another non-suspected maneuver 1833.

During a learning phase the maneuver 1832 is applied using certain driving parameters. The one or more impact parameters may be calculated based on the certain driving parameters and an evaluation of whether these one or more impact parameters have one or more allowable values can be made. Assuming that the one or more impact parameters have one or more allowable values then the comfort based autonomic driving pattern may follow the maneuver 1832 when detecting such an event in the future.

Alternatively, maneuver 1832 may be executed by an autonomous vehicle, when detecting a future occurrence of a driving over obstacle 1841.

Referring back to the learning process—the learning process may include acquiring, by first vehicle 1801 environmental metadata such as first plurality (N1) of images I1(1)-I1(N1) 1700(1,1)-1700(1,N1) during obstacle avoidance maneuver 1832.

The environmental metadata (such as visual information V1(1)-V1(N1) 1702(1,1)-1702(1,N1)) is sent from first vehicle 1801 to computerized system (CS) 400 via network 1720.

The visual information may be the images themselves. Additionally or alternatively, the first vehicle may process the images to provide a representation of the images.

First vehicle 1801 may also transmit physical metadata P1(1)-P1(N1) 1704(1,1)-1704(1,N1) obtained during maneuver 1832.

Alternatively, during an applying process, the vehicle may detect an driving event that includes the obstacle and may apply the relevant comfort based autonomous driving pattern.

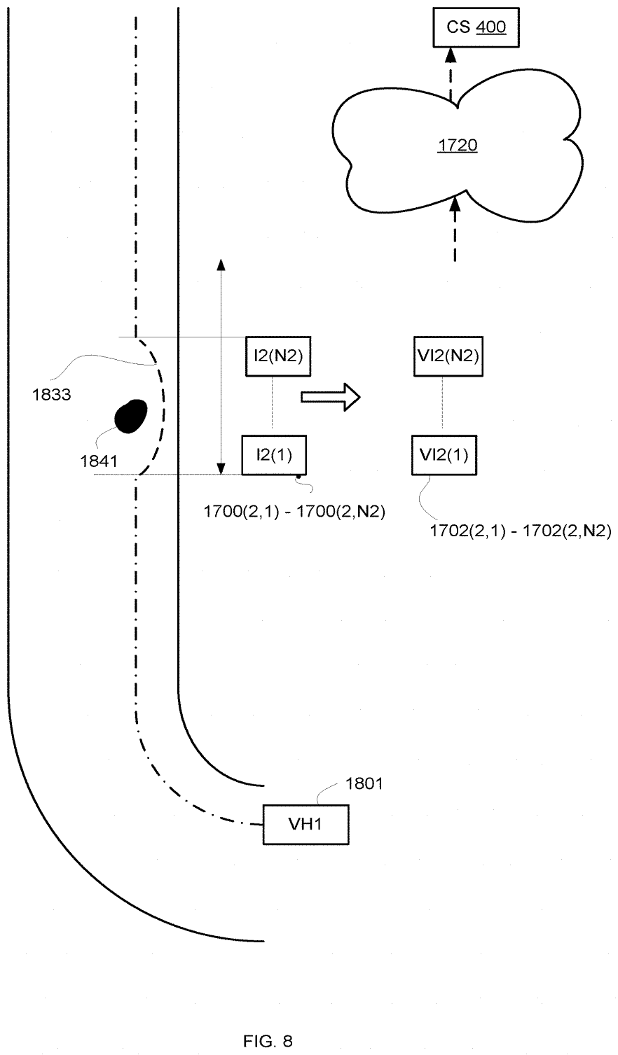

FIG. 8 illustrates VH1 1801 that propagates along a road 1820. VH1 1801 performs a maneuver 1833 suspected as being an obstacle avoidance maneuver when encountered with obstacle 1841. Maneuver 1833 is preceded by a non-suspected maneuver and is followed by another non-suspected maneuver.

VH1 1801 acquires a second plurality (N2) of images I2(1)-I2(N2) 1700 (2,1)-1700 (2, N2) during maneuver 1833.

Environmental metadata such as visual information V2(1)-V2(N2) 1702(2,1)-1702(2,N2) is sent from VH1 1801 to computerized system (CS) 400 via network 1720.

The visual information may be the images themselves. Additionally or alternatively, second vehicle processes the images to provide a representation of the images.

VH1 may also transmit driving information such as physical metadata (not shown) that represents the behavior of the vehicle during maneuver 1832.

Alternatively, during an applying process, the vehicle may detect an driving event that includes the obstacle and may apply the relevant comfort based autonomous driving pattern.

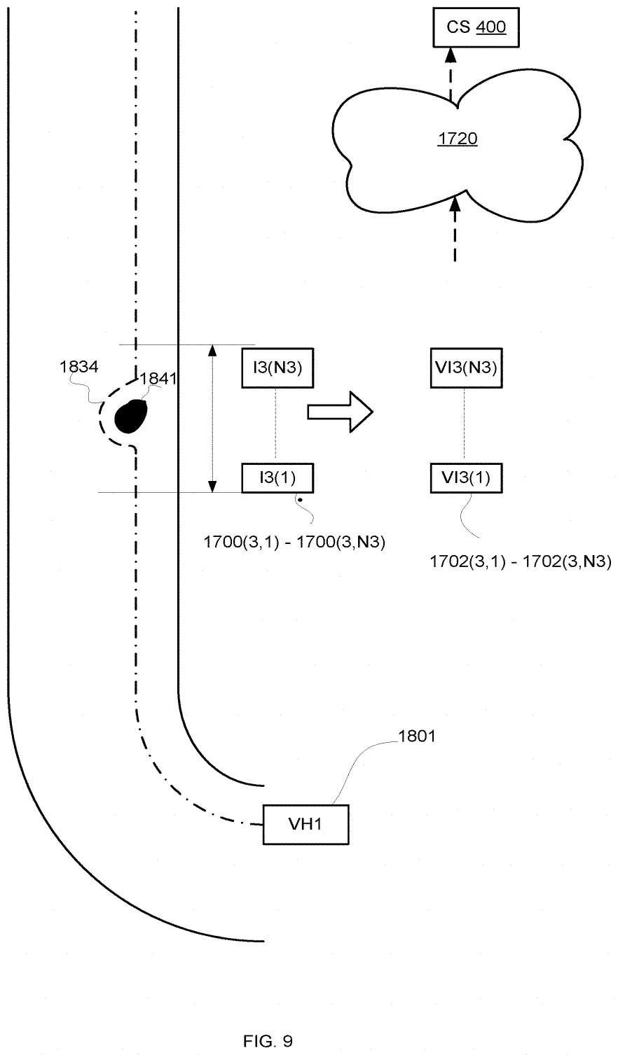

FIG. 9 illustrates VH1 1801 that propagates along a road. Third vehicle 1803 performs a maneuver 1834 suspected as being an obstacle avoidance maneuver when encountered with obstacle 1841. Maneuver 1834 is preceded by a non-suspected maneuver and is followed by another non-suspected maneuver.

VH1 acquires a third plurality (N3) of images I3(1)-I3(N3) 1700(3,1)-1700(3,N3) during maneuver 1834.

Environmental metadata such as visual information V3(1)-V3(N3) 1702(3,1)-1702(3,N3) is sent from VH1 1801 to computerized system (CS) 400 via network 1720.

The visual information may be the images themselves. Additionally or alternatively, third vehicle processes the images to provide a representation of the images.

VH1 may also transmit driving information such as physical metadata (not shown) that represents the behavior of the vehicle during maneuver 1832.

Alternatively, during an applying process, the vehicle may detect an driving event that includes the obstacle and may apply the relevant comfort based autonomous driving pattern.

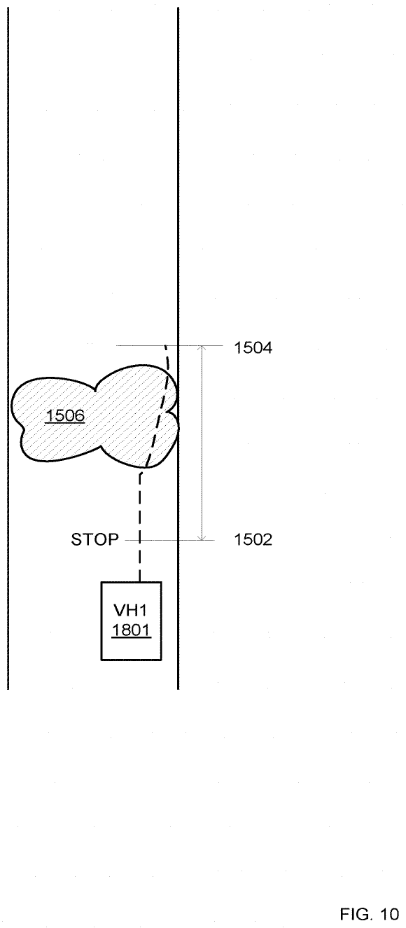

FIG. 10 illustrates first vehicle VH1 1801 as stopping (position 1502) in front of a puddle 1506 and then passing the puddle (may drive straight or change its direction till ending the maneuver at point 1504. The vehicle can generate and send driving information and Environmental metadata related to the passage over the puddle.

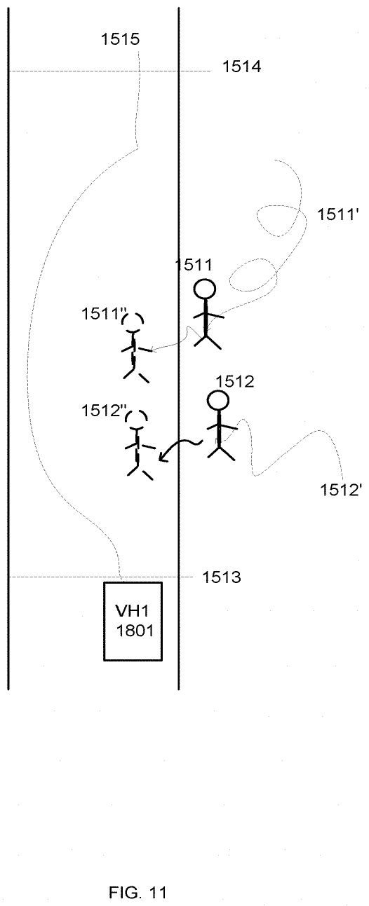

FIG. 11 illustrates first vehicle VH1 1801 as sensing pedestrians 1511 and 1512. The vehicle may sense the movements of the pedestrians—which may be regarded as sensor environmental information.

Environmental metadata such as visual information acquired between positions 1513 and 1514 (end of the maneuver) may be sent to the server.

Alternatively, during an applying process, the vehicle may detect an driving event that includes the pedestrians (and even their speed or any other parameter related to their walking pattern) parking vehicles and may apply the relevant comfort based autonomous driving pattern.

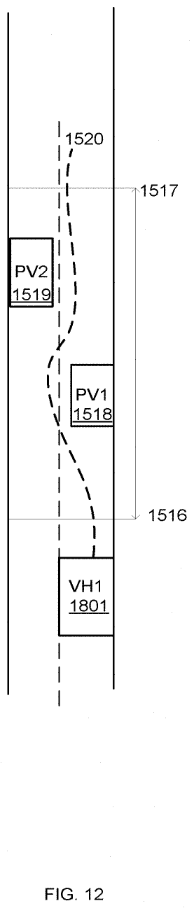

FIG. 12 illustrates first vehicle VH1 1801 as sensing parked vehicles PV1 1518 and PV2 1519 that part on both sides of a double-lane bi-directional road, that require the first vehicle to perform a complex maneuver 1520 that includes changing lanes and changing direction relatively rapidly.

Driving information and Environmental metadata related to the driving between the vehicles may be obtained and sent to the remote computer that generates a comfort based autonomous driving pattern.

Alternatively, during an applying process, the vehicle may detect an driving event that includes the parking vehicles and may apply the relevant comfort based autonomous driving pattern.

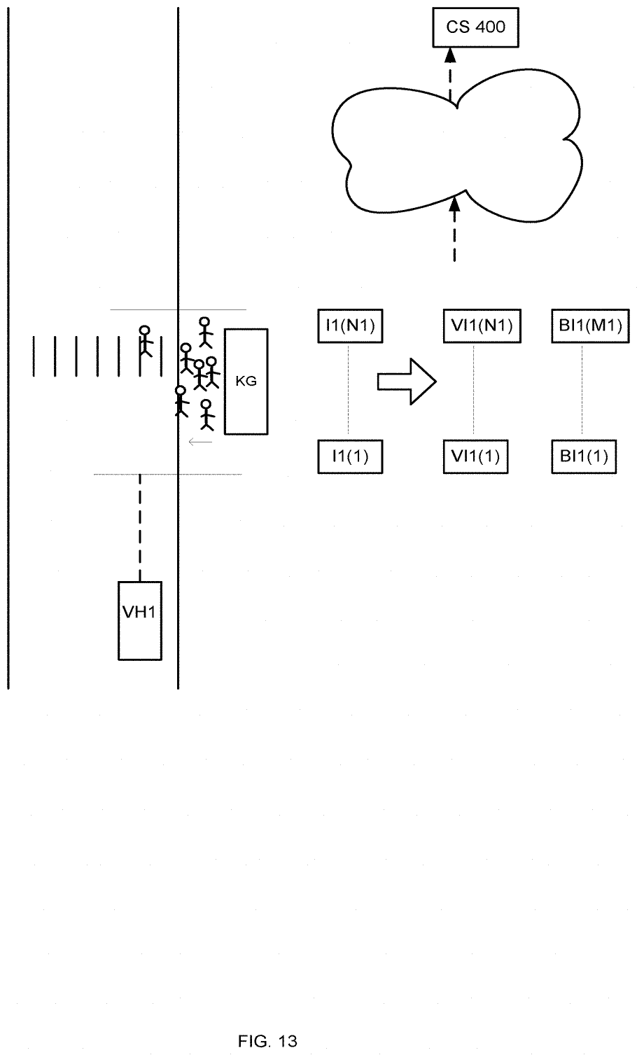

FIG. 13 illustrates a vehicle that approaches a zebra crossing located near a kindergarten and pedestrians that pass the zebra crossing.

Driving information and Environmental metadata related to the zebra crossings near the kindergarten and the pedestrians may be obtained and sent to the remote computer that generates a comfort based autonomous driving pattern.

Alternatively, during an applying process, the vehicle may detect an driving event that includes the zebra crossings near the kindergarten and the pedestrians and may apply the relevant comfort based autonomous driving pattern.

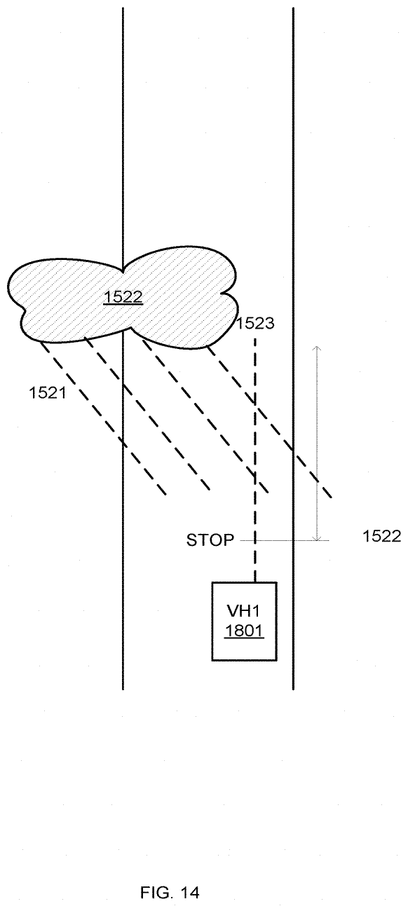

FIG. 14 illustrates first vehicle VH1 1801 as stopping (position 1522) in front of wet segment of the road on which rain 1521 (from cloud 1522) falls. The stop (at location 1522) and any further movement after moving to another part of the road may be regarded as a maneuver 1523 that is indicative that passing the wet segment may require human intervention.

Visual information acquired between position 1522 (beginning of the maneuver) and the end of the maneuver are processed during step 1494.

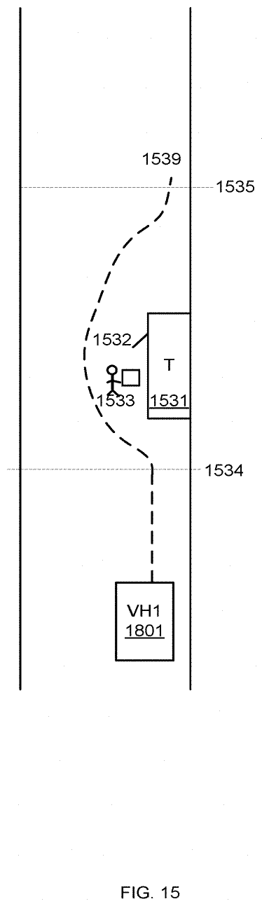

FIG. 15 illustrates first vehicle VH1 1801 as stopping (position 1534) in front of a situation that may be labeled as a packing or unpacking situation—a track 1531 is parked on the road, there is an open door 1532, and a pedestrian 1533 carries luggage on the road. The first vehicle 1801 bypasses the truck and the pedestrian between locations 1534 and 1535 during maneuver 1539. The maneuver may be indicative that a packing or unpacking situation may require human intervention.

Driving information and environmental metadata related to packing or unpacking situation may be obtained and sent to the remote computer that generates a comfort based autonomous driving pattern.

Alternatively, during an applying process, the vehicle may detect an driving event that includes packing or unpacking situation and may apply the relevant comfort based autonomous driving pattern.

Visual information acquired between positions 1534 and 1535 are processed during step 1494.

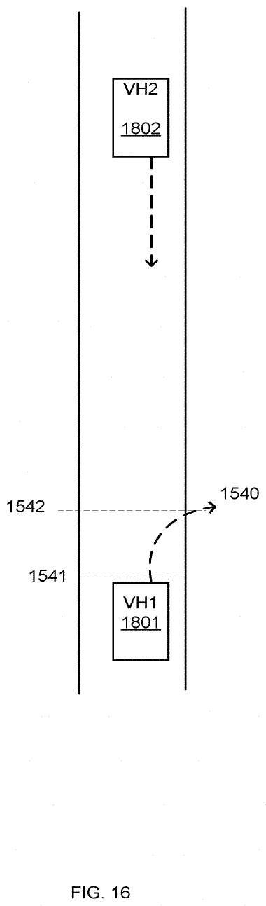

FIG. 16 illustrates first vehicle VH1 1801 as turning away (maneuver 1540) from the road when sensing that it faces a second vehicle VH2 1802 that moves towards VH1 1801.

Driving information and environmental metadata related to the potential face to face collision may be obtained and sent to the remote computer that generates a comfort based autonomous driving pattern.

Alternatively, during an applying process, the vehicle may detect an driving event that includes the potential face to face collision and may apply the relevant comfort based autonomous driving pattern.

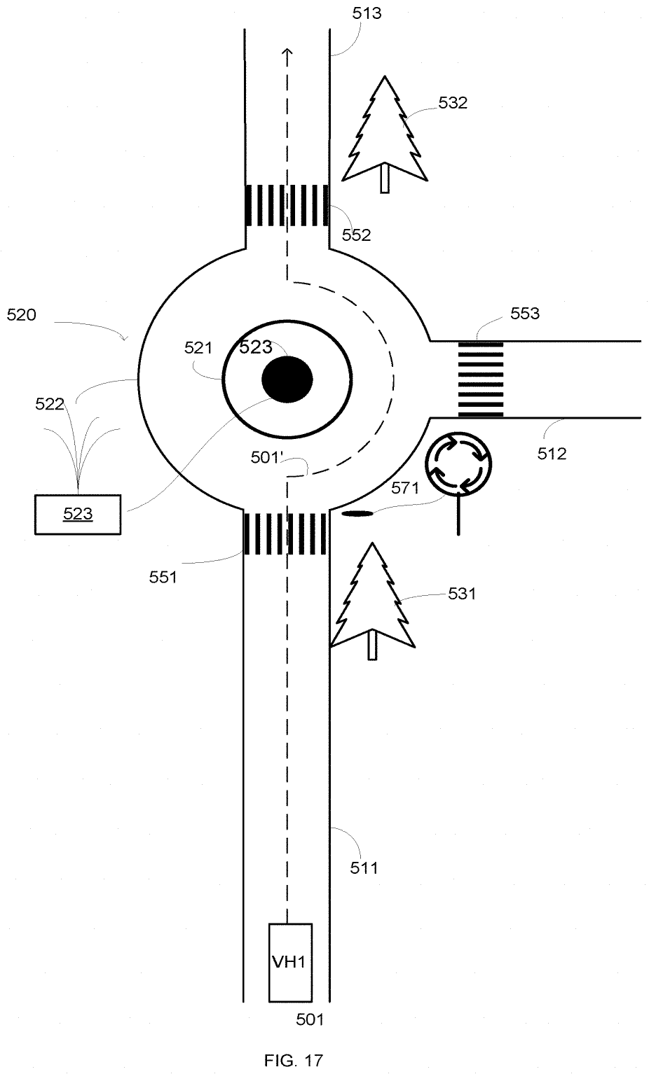

FIG. 17 illustrates first vehicle VH1 1801 as driving through a roundabout 520 that has three arms 511, 512 and 512. VH1 1801 approaches the roundabout (from arm 511), drives within the roundabout and finally exits the roundabout and drives in arm 513. The driving pattern is denoted 501′.

The roundabout 520 is preceded by a roundabout related traffic sign 571, by first tree 531 and by first zebra crossing 551. Arm 512 includes a second zebra crossing 553. Third arm includes third zebra crossing 552. A fountain 523 is positioned in the inner circle 521 of the roundabout. The roundabout has an external border 522. The roundabout is preceded by second tree 532.

Driving information and Environmental metadata related to the potential roundabout may be obtained and sent to the remote computer that generates a comfort based autonomous driving pattern.

Alternatively, during an applying process, the vehicle may detect an driving event that includes the potential roundabout and may apply the relevant comfort based autonomous driving pattern.

The roundabout (or more exactly driving through a roundabout or approaching a roundabout) may be regarded as an driving event. Alternatively an driving event may be defined per the roundabout and one or more other features related to the roundabout—such as the number of arms, the relative position of the arms, the size of the roundabout, the number of cross roads, the size of the inner circle, the fountain in the center of the roundabout, and the like.

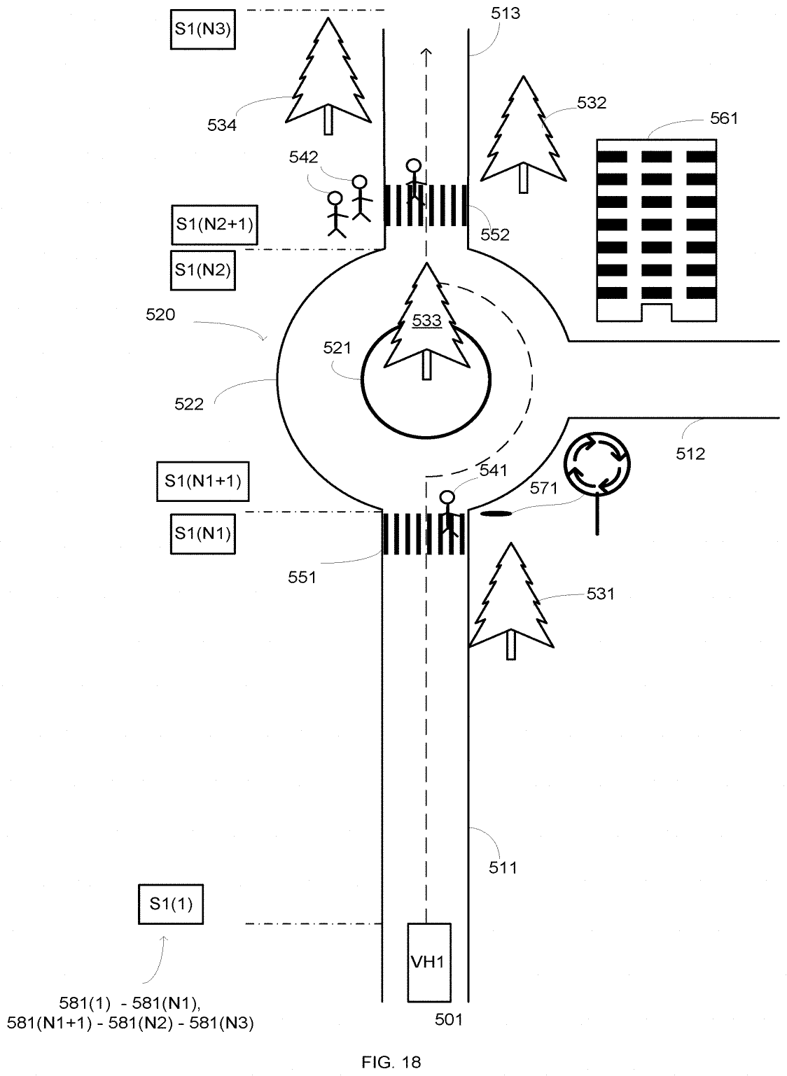

FIG. 18 illustrates first vehicle VH1 1801 as driving through a roundabout 520 that has three arms 511, 512 and 512. VH1 1801 approaches the roundabout (from arm 511), drives within the roundabout and finally exits the roundabout and drives in arm 513. The driving pattern is denoted 501′. FIG. 18 also illustrates pedestrians 541 and 542 that cross first and third zebra crossings 551 and 552 respectively.

FIGS. 18 and 17 may describe an driving event of the same type—but these figures may represent different driving events—due to the presence of pedestrians in FIG. 18.

FIG. 18 also illustrates environmental metadata generated by the vehicle—581(1)—581(N1), 581(N1+1)—581(N2)—581(N3).

In any of the methods any of the autonomous driving pattern related to The driving event may be amended based on feedback provided by users of the vehicle.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for comfort based autonomous driving, the method comprises:
receiving, from vehicles, multiple driving event metadata or generating the multiple driving event metadata;
wherein the multiple driving event metadata is related to multiple driving events; wherein each driving event metadata is associated to a driving event and comprises (a) environmental metadata regarding an environment of the vehicle that is related to the driving event, and (b) physical metadata indicative of at least one physical parameter of the vehicle that is related to the driving event;
generating driving event identifiers for identifying each driving event;
evaluating one or more impact parameters for each driving event, wherein the evaluating is responsive to the physical metadata related to the driving event, wherein the one or more impact parameters are indicative of an impact of the driving event on a person located within a vehicle;
receiving or generating one or more allowable values of the one or more impact parameters, the one or more allowable values represent an allowable comfort of the person;
determining, based on the one or more allowable values of the one or more impact parameters, comfort based autonomous driving pattern information, wherein the comfort based autonomous driving pattern information is indicative of a comfort based autonomous driving pattern to be applied by the vehicle during an occurrence of the driving event; and
storing in at least one data structure (a) the driving event identifiers, and (b) comfort based autonomous driving pattern information for each one of the driving events.

2. The method according to claim 1, wherein the one or more physical parameters are selected out of speed, acceleration, displacement, and direction of propagation.

3. The method according to claim 1, wherein the generating the multiple driving event metadata comprises (i) receiving, from the vehicles, environmental information and physical information acquired by the vehicles during various time windows, (ii) detecting multiple driving events that occurred during the time windows, and (iii) extracting the environmental information and physical information acquired by the vehicles during the driving events.

4. The method according to claim 1, comprising generating the one or more allowable values of the one or more impact parameters is based on a statistical analysis of driving patterns applied by the multiple vehicle during the driving events.

5. The method according to claim 1, comprising generating the one or more allowable values of the one or more impact parameters is based on typical driving patterns applied by the multiple vehicle during the driving events.

6. The method according to claim 1, comprising generating the one or more allowable values of the one or more impact parameters is based on feedback from at least one person within at least one of the multiple vehicles.

7. The method according to claim 1, comprising generating the one or more allowable values of the one or more impact parameters is based on a monitoring process that involve monitoring at least one response of at least one person within at least one of the multiple vehicles to at least one of the multiple driving events.

8. The method according to claim 1, wherein the multiple driving events are related to obstacles.

9. The method according to claim 1, wherein the multiple driving events are related to physical obstacles.

10. The method according to claim 1, wherein the multiple driving events are related to weather conditions.

11. The method according to claim 1, wherein the allowable comfort of the person is represented by one or more comfort threshold.

12. The method according to claim 1 wherein the determining of the comfort based autonomous driving pattern information, is responsive to a plurality of allowable values of a plurality of impact parameters.

13. A non-transitory computer readable medium that stores instructions for:
receiving, from vehicles, multiple driving event metadata or generating the multiple driving event metadata;
wherein the multiple driving event metadata is related to multiple driving events;
wherein each driving event metadata is associated to a driving event and comprises (a) environmental metadata regarding an environment of the vehicle that is related to the driving event, and (b) physical metadata indicative of at least one physical parameter of the vehicle that is related to the driving event;
generating driving event identifiers for identifying each driving event;
evaluating one or more impact parameters for each driving event, wherein the evaluating is responsive to the physical metadata related to the driving event, wherein the one or more impact parameters are indicative of an impact of the driving event on a person located within a vehicle;
receiving or generating one or more allowable values of the one or more impact parameters, the one or more allowable values represent an allowable comfort of the person;
determining, based on the one or more allowable values of the one or more impact parameters, comfort based autonomous driving pattern information, wherein the comfort based autonomous driving pattern information is indicative of a comfort based autonomous driving pattern to be applied by the vehicle during an occurrence of the driving event; and
storing in at least one data structure (a) the driving event identifiers, and (b) comfort based autonomous driving pattern information for each one of the driving events

14. The non-transitory computer readable medium according to claim 14, wherein the one or more physical parameters are selected out of speed, acceleration, displacement, and direction of propagation.

15. The non-transitory computer readable medium according to claim 14, wherein the generating the multiple driving event metadata comprises (i) receiving, from the vehicles, environmental information and physical information acquired by the vehicles during various time windows, (ii) detecting multiple driving events that occurred during the time windows, and (iii) extracting the environmental information and physical information acquired by the vehicles during the driving events.

16. The non-transitory computer readable medium according to claim 14, that stores instructions for generating the one or more allowable values of the one or more impact parameters is based on a statistical analysis of driving patterns applied by the multiple vehicle during the driving events.

17. The non-transitory computer readable medium according to claim 14, that stores instructions for generating the one or more allowable values of the one or more impact parameters is based on typical driving patterns applied by the multiple vehicle during the driving events.

18. The non-transitory computer readable medium according to claim 14, that stores instructions for generating the one or more allowable values of the one or more impact parameters is based on feedback from at least one person within at least one of the multiple vehicles.

19. The non-transitory computer readable medium according to claim 14, comprising that stores instructions for generating the one or more allowable values of the one or more impact parameters is based on a monitoring process that involve monitoring at least one response of at least one person within at least one of the multiple vehicles to at least one of the multiple driving events.

20. The non-transitory computer readable medium according to claim 14, wherein the multiple driving events are related to obstacles.

21. The non-transitory computer readable medium according to claim 14, wherein the multiple driving events are related to physical obstacles.

22. The non-transitory computer readable medium according to claim 14, wherein the multiple driving events are related to weather conditions.

23. The non-transitory computer readable medium according to claim 14, wherein the allowable comfort of the person is represented by one or more comfort threshold.

24. The non-transitory computer readable medium according to claim 14 wherein the determining of the comfort based autonomous driving pattern information, is responsive to a plurality of allowable values of a plurality of impact parameters.

25. A method for driving a vehicle, the method comprises: receiving, by the vehicle, multiple driving event identifiers related to multiple types of driving events that occurred during a driving of the vehicle over a path, and (b) comfort based autonomous driving pattern information for each one of the multiple types of driving events; wherein a comfort based autonomous driving pattern information of an driving event is indicative of a comfort based autonomous driving pattern associated to the driving event; sensing, by the vehicle and while driving on a current path, currently sensed information that is indicative of a vicinity of the vehicle and is indicative of a current path; searching, based on the currently sensed information, for a driving event identifier out of the multiple driving event identifiers; when detecting an driving event then applying an autonomous driving pattern that is associated to the driving event.
